(19) United States
(12) Patent Application Publication
(10) Pub. No.: US 2016/0046523 A1
(43) Pub. Date: Feb. 18, 2016

(54) Moisture Barrier Composite Film And Its Preparation Method

(71) Applicant: CHUNG-YUAN CHRISTIAN UNIVERSITY, Tao-Yuan (TW)

(72) Inventors: Jung-Tsai Chen, Taoyuan County (TW); Chien-Chieh Hu, Taoyuan County (TW); Kueir-Rarn Lee, Taoyuan County (TW); Juin-Yih Lai, Taoyuan County (TW)

(21) Appl. No.: 14/521,087

(22) Filed: Oct. 22, 2014

(30) Foreign Application Priority Data
Aug. 18, 2014 (TW) 103128356

(51) Int. Cl. C03C 17/32; B05D 3/10; B29C 39/12; B05D 5/00; B05D 7/00; B29C 39/02; B05D 1/38; B05D 3/00

(52) U.S. Cl. CPC C03C 17/328; B05D 1/38; B05D 3/107; B05D 3/007; B05D 5/00; B05D 7/52; B29C 39/025; B29C 39/123; C03C 17/32; B29L 2009/005

(57) ABSTRACT

The invention provides a moisture barrier composite film, formed by having a mixture of thermally reduced graphene and cyclic olefin copolymer be formed into a film and forming a hydrophilic surface layer on surfaces of the moisture barrier composite film by a hydrophilic agent; wherein a ratio of carbon atoms to oxygen atoms in thermally reduced graphene is more than 30 and the hydrophilic surface layer has a density of 0.01˜1.0 mg/cm².

### BACKGROUND OF THE INVENTION

1. Field of the Invention

The present invention is generally related to a moisture barrier composite film and its preparation method, and more particularly to a moisture barrier composite film and its preparation method using cyclic olefins and graphene.

2. Description of the Prior Art

A high gas barrier and moisture barrier film can be not only used as packaging materials and but also gradually extensively applied as substrates or sealing films of electronic devices accompanying with development of flexible electronic products. Usually, a film composed of inorganic materials has a better barrier effect. For example, inorganic films such as SiO₂ or organic/inorganic alternately deposited multi-layered films can be used as a gas barrier and moisture barrier film. However, film deposition or atomic layer deposition to deposit atomic or molecular scaled dense films may obtain a film have high barrier, high light transmittance, a high coverage rate and high uniformity but these methods not only require expensive instrument but also need to repeatedly deposit multiple barrier layers in order to achieve high gas and moisture barrier effect. Thus, it has time consuming and high cost problems.

Furthermore, since molecular chains of a hydrophilic polymer have strong hydrogen bonding to become piling up or even to form crystals, a hydrophilic polymer has good gas barrier performance. But, as for the moisture barrier performance, a hydrophilic polymer will be plasticized with water to lose its water barrier characteristic and thus cannot achieve the expected water barrier performance when used as a raw material for a moisture barrier film. However, as a hydrophobic polymer is used as a polymer matrix for a moisture barrier film, such as cyclic olefin copolymer (COC) having a high glass transition temperature (80˜160° C.), high transmittance (>90%), good mechanical strength, low waster absorbance and excellent moisture barrier performance as a substrate, the resulting film still cannot meet the requirements of electronic products.

A report in 2012 by Nair et al. disclosed a graphene oxide (GO) film can block permeation of inert gas, even block helium gas, but can permeate polar molecules such as alcohol and has no barrier to water. Therefore, GO can be used as a filler in COC to promote moisture barrier performance. Nair et al. reported that GO is thermally reduced to graphene (redcued GO; RGO) and found that gas and polar molecules including water are impermeable through RGO. Yousefi et al. (N. Yousefi, M. M. Gudarzi, Q. Zheng, X. Lin, X. Shen, J. Jia, F. Sharif, J.-K. Kim, Highly aligned, ultralarge-size reduced graphene oxide/polyurethane nanocomposites: Mechanical properties and moisture permeability, Composites Part A: Applied Science and Manufacturing, 49 (2013) 42-50) reported that the PU film can have a lower water vapor permeation rate by adding RGO to the PU film. Tsai et al. (M.-H. Tsai, I. H. Tseng, Y.-F. Liao, J.-C. Chiang, Transparent polyimide nanocomposites with improved moisture barrier using graphene, Polymer International, 62 (2013) 1302-130) reported that a PI/graphene film was prepared and found that the addition of graphene can lower the water vapor permeation rate. The addition of thermally reduced graphene (TRG) can effectively enhance moisture barrier performance but further improvement on the moisture barrier performance for a COC/TRG composite film is still urgently required.

### SUMMARY OF THE INVENTION

In light of the above background, in order to fulfill the requirements of industries, one object of the present invention is to provide a moisture barrier composite film and its preparation method to blending graphene in cyclic olefin copolymers as the polymer matrix to increase moisture barrier performance by the high aspect ratio of graphene and the interaction between graphene and cyclic olefin copolymers so as to meet the requirements of electronic products.

One object of the present invention is to provide a method for preparing a moisture barrier composite film to use a solution film casting method to prepare a barrier film and to use an amphoteric polymer to perform surface hydrophilic processing to form a hydrophilic surface layer which can catch moisture to form a barrier layer to further increase moisture barrier performance. Furthermore, thermal treatment after the composite film is formed can further increase moisture barrier performance.

One object of the present invention is to provide a moisture barrier composite film to increase moisture barrier performance and maintain a proper level of light transmittance by having a small amount of thermally reduced graphene in cyclic olefin copolymers and to further increase moisture barrier performance by forming a hydrophilic surface layer made of amphoteric polymers.

Accordingly, one embodiment of the present invention provides a method for preparing a moisture barrier composite film, comprising: providing a graphene dispersed solution; dissolving cyclic olefin copolymer in the graphene dispersed solution to obtain a casting solution; performing a solution film casting procedure to coat the casting solution on a glass substrate to form a coating film; and performing a film drying procedure to dry the coating film to separate from the glass substrate to obtain a moisture barrier composite film. The method further comprises: performing a surface modification procedure to modify surfaces of the moisture barrier composite film to become hydrophilic by using a hydrophilic modifier to coat on the surfaces of the moisture barrier composite film by a drop casting method to form a hydrophilic surface layer on the surfaces of the moisture barrier composite film after drying.

Another embodiment of the present invention provides a moisture barrier composite film, formed by having a mixture of thermally reduced graphene and cyclic olefin copolymer be formed into a film and forming a hydrophilic surface layer on surfaces of the moisture barrier composite film by a hydrophilic agent; wherein a ratio of carbon atoms to oxygen atoms in thermally reduced graphene is more than 30 and the hydrophilic surface layer has a density of 0.01˜1.0 mg/cm². According to the moisture barrier composite film and its preparation method of the present invention, the composite film has a high glass transition temperature, high transmittance, good mechanical strength and excellent moisture barrier performance.

### BRIEF DESCRIPTION OF THE DRAWINGS

FIG. 1 shows a flow chart of a method for preparing a moisture barrier composite film according to one embodiment of the present invention;

FIGS. 2(a) to (c) show a schematic diagram illustrating a structure of a moisture barrier composite film according to one embodiment of the present invention;

FIG. 3 shows a schematic diagram illustrating the relationship of the surface density of the hydrophilic surface layer of the moisture barrier composite film and the relative moisture permeation rate according to one embodiment of the present invention;

FIG. 4 shows a schematic diagram illustrating the relationship of the surface density of the hydrophilic surface layer of the moisture barrier composite film and the water contact angle according to one embodiment of the present invention;

FIG. 5 shows a schematic diagram illustrating the relationship of the content of graphene in the moisture barrier composite film and glass transition temperature (Tg) according to one embodiment of the present invention;

FIG. 6 shows a schematic diagram illustrating FTIR spectra of graphene and TRG of the moisture barrier composite film according to one embodiment of the present invention;

FIG. 7 shows a schematic diagram illustrating X-ray photoelectron spectra of graphene and TRG of the moisture barrier composite film according to one embodiment of the present invention;

FIG. 8 shows a schematic diagram illustrating X-ray photoelectron C1s spectra of TRG of the moisture barrier composite film according to one embodiment of the present invention;

FIG. 9 shows a schematic diagram illustrating X-ray diffraction spectra of graphene and TRG of the moisture barrier composite film according to one embodiment of the present invention;

FIG. 10 shows a schematic diagram illustrating Raman spectra of graphene and TRG of the moisture barrier composite film according to one embodiment of the present invention;

FIG. 11(a) shows a schematic diagram illustrating the relationship of graphene of the moisture barrier composite film and the absorption and desorption of N₂ according to one embodiment of the present invention.

FIG. 11(b) shows a schematic diagram illustrating the relationship of TRG of the moisture barrier composite film and the absorption and desorption of N₂ according to one embodiment of the present invention;

FIG. 12 shows a schematic diagram illustrating the height distribution of TRG of the moisture barrier composite film by an atomic force microscope according to one embodiment of the present invention;

FIG. 13 shows a schematic diagram illustrating the relationship of the content of TRG of the moisture barrier composite film and the relative moisture permeation rate (P/P₀) according to one embodiment of the present invention where P is the permeation rate of the COC/TRG-X composite film and P₀ is the permeation rate of the COC film.

FIG. 14 shows a schematic diagram illustrating UV-Vis spectra of the COC/TRG-X composite film with different content of TRG according to one embodiment of the present invention;

FIG. 15 shows a schematic diagram illustrating the relationship of the content of TRG of the moisture barrier composite film and transmittance at 550 nm according to one embodiment of the present invention; and

FIG. 16 shows a schematic diagram illustrating DSC spectrum of COC film of the moisture barrier composite film according to one embodiment of the present invention.

### DESCRIPTION OF THE PREFERRED EMBODIMENTS

What is probed into the invention is a moisture barrier composite film. Detail descriptions of the steps, structure and elements will be provided in the following in order to make the invention thoroughly understood. Obviously, the application of the invention is not confined to specific details familiar to those who are skilled in the art. On the other hand, the common steps, structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

According to a first embodiment of the present invention, a method for preparing a moisture barrier composite film is provides. The method comprises: providing a graphene dispersed solution; dissolving cyclic olefin copolymer in the graphene dispersed solution to obtain a casting solution; performing a solution film casting procedure to coat the casting solution on a glass substrate to form a coating film; and performing a film drying procedure to dry the coating film to separate from the glass substrate to obtain a moisture barrier composite film. The method further comprises: performing a surface modification procedure to modify surfaces of the moisture barrier composite film to become hydrophilic by using a hydrophilic modifier to coat on the surfaces of the moisture barrier composite film by a drop casting method to form a hydrophilic surface layer on the surfaces of the moisture barrier composite film after drying.

In one embodiment, the hydrophilic modifier is made by dissolving an amphoteric polymer in an ethanol containing aqueous solution.

In one embodiment, the amphoteric polymer is (poly(ethylene oxid)-poly(propylene oxid)-poly(ethylene oxid) triblock copolymer or poly(4-styrenesulfonic acid), the ethanol containing aqueous solution is an aqueous solution containing 20 wt % of ethanol and the hydrophilic surface layer has a density with a range of 0.01˜1.0 mg/cm².

In one embodiment, the graphene dispersed solution is obtained by thermally reduce graphene oxide to produce thermally reduced graphene and dissolving the thermally reduced graphene in chloroform.

In one embodiment, the method further comprises performing a stripping procedure after the film drying procedure to separate from the glass substrate to obtain a moisture barrier composite film.

In one embodiment, the cyclic olefin copolymer is formed by polymerization of ethylene and norbornene.

In one embodiment, the thermally reduced graphene has a molar fraction of oxygen element be less than 3 mol %. That is, a ratio of carbon atoms to oxygen atoms in thermally reduced graphene is more than 30. The ratio of carbon atoms to oxygen atoms in thermally reduced graphene is determined by quantitative analysis of chemical elements on TRG by XPS. The original or unprocessed graphene oxide contains about 30 mol % of oxygen elements and the thermally reduced graphene contains only about 2.86 mol % of oxygen elements. The ratio of C/O is about 34.0 and chemically reduced graphene (CRG) has a ratio of C/O be around 2.5˜21.2.

In one embodiment, the method further comprises a thermal treatment process to process the composite at a temperature higher than the glass transition temperature of the cyclic olefin copolymer in the moisture barrier composite film. For example, the temperature is raised to 80° C. and then to 100° C. for 24 hrs.

According to a second embodiment of the present invention, a moisture barrier composite film is provided. The composite film is formed by having a mixture of thermally reduced graphene and cyclic olefin copolymer be formed into a film and forming a hydrophilic surface layer on surfaces of the moisture barrier composite film by a hydrophilic agent; wherein a ratio of carbon atoms to oxygen atoms in thermally reduced graphene is more than 30 and the hydrophilic surface layer has a density of 0.01˜1.0 mg/cm².

In one embodiment, the thermally reduced graphene in the moisture barrier composite film is 0.05˜0.8 wt %; the hydrophilic agent is poly(4-styrenesulfonic acid); and the hydrophilic surface layer has a density of 0.1 mg/cm². In another embodiment, the thermally reduced graphene in the moisture barrier composite film is 0.05˜0.8 wt %; and the hydrophilic agent is (poly(ethylene oxid)-poly(propylene oxid)-poly(ethylene oxid) triblock copolymer; and the hydrophilic surface layer has a density of 0.01 mg/cm².

In one embodiment, the moisture barrier composite film has a water contact angle of less than 60 degrees and has a water vapor permeation rate of less than 1.0 g·mm/m²/day. Preferably, the thermally reduced graphene in the moisture barrier composite film is about 0.06 wt %; the hydrophilic agent is (poly(ethylene oxid)-poly(propylene oxid)-poly(ethylene oxid) triblock copolymer; the hydrophilic surface layer has a density of 0.01 mg/cm²; and the moisture barrier composite film has light transmittance of more than 85% and a water vapor permeation rate of less than 0.07 g·mm/m²/day.

In one embodiment, the moisture barrier composite film has a glass transition temperature higher than the cyclic olefin copolymer that forms into the moisture barrier composite film. Preferably, the moisture barrier composite film has a glass transition temperature of higher than 95° C.

The following examples are used to further illustrate the present invention but the present invention is not limited to these examples.

### Example 1

### Preparation of a Moisture Barrier Composite Film

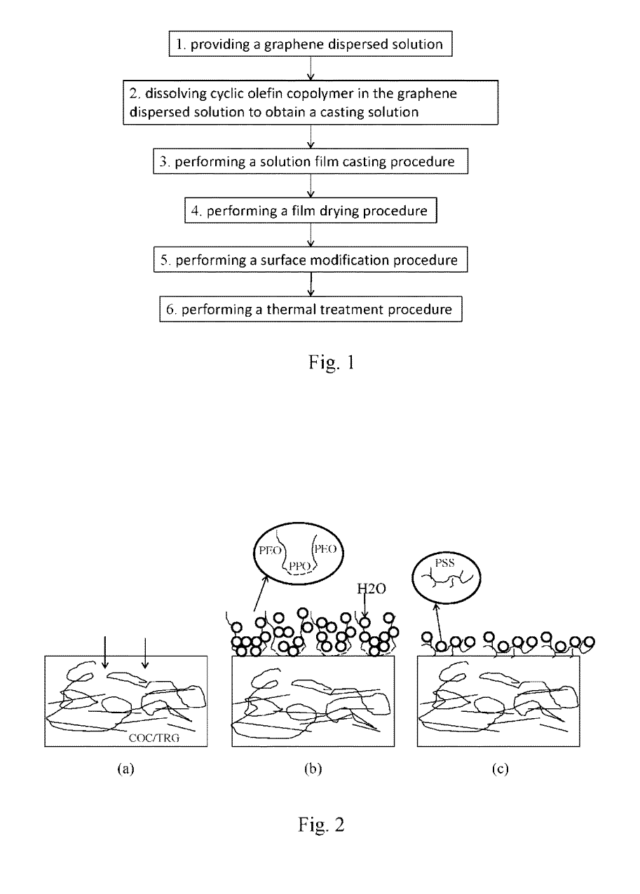

FIG. 1 shows a flow chart of a method for preparing a moisture barrier composite film according to one embodiment of the present invention.

1. Graphene is prepared by using the modified Hummer's method to generate GO nano flakes and thermally reduce the GO nano flakes to produce graphene. In a 15% H₂/85% N₂ environment, the temperature is suddenly raised to 300° C. and maintained for 2 hrs to have oxygen containing groups between graphene layers to break to generate CO and CO₂. A high pressure is used to exfoliate GO and the temperature is raised to 1000° C. by a temperature rising rate of 0.5° C./min and maintain for 2 hrs to perform the thermal reduction procedure to thereby obtain thermally reduced graphene oxide (TRG).

2. At first, 1.8, 3.6, 5.4, 7.2 and 9.0 mg of TRG are weighted and dispersed in 60 mL of chloroform. Exfoliation for 4 hrs by ultrasonic oscillation is performed. 9 g of COC (cyclic olefin copolymers; TOPAS-5013) is placed in the TRG dispersed chloroform solution and the mixture is stirred for 12 hrs by a magnetic stirrer. COC is completely dissolved and 0.15/mL casting solutions containing 0, 0.02, 0.04, 0.06, 0.08 and 0.1 wt % of TRG are obtained. In a hood, a proper amount of the casting solution is used to pour on a glass plate and a 600 μm doctor blade scrapes the solution to form a casting film. The casting film is dried at room temperature for 1 hr. The COC film and COC/TRG film are vacuum-dried at 50° C. for 24 hrs to remove solvents.

3. The surface modification process is performed. PEO-PPO-PEO ((poly(ethylene oxid)-poly(propylene oxid)-poly(ethylene oxid) triblock copolymer; Asahi Electric Industry Co. Ltd.; Pluronic™ F-108; Total Mw=14,600, PEO=11,680, PPO=2920) and PSS (poly(4-styrenesulfonic acid); Sigma Aldrich; Mw=75,000; 18 wt % in H₂O) were dissolved in an aqueous solution containing 20 wt % of ethanol to prepare a hydrophilic agent. 2 mL of the hydrophilic agent is coated on the COC or COC/TRG films (5 cm diameter) mounted on a chuck by a drop casting method. In an oven at 50° C., the films are dried for 24 hrs to form a self-assembly hydrophilic layer on the surface.

4. The thermal treatment is performed. In order to prevent the film from distortion due to high temperature, the film is placed in an oven at 80° C. for 1 hr and then treated at 80, 100 and 120° C. for 24 hrs.

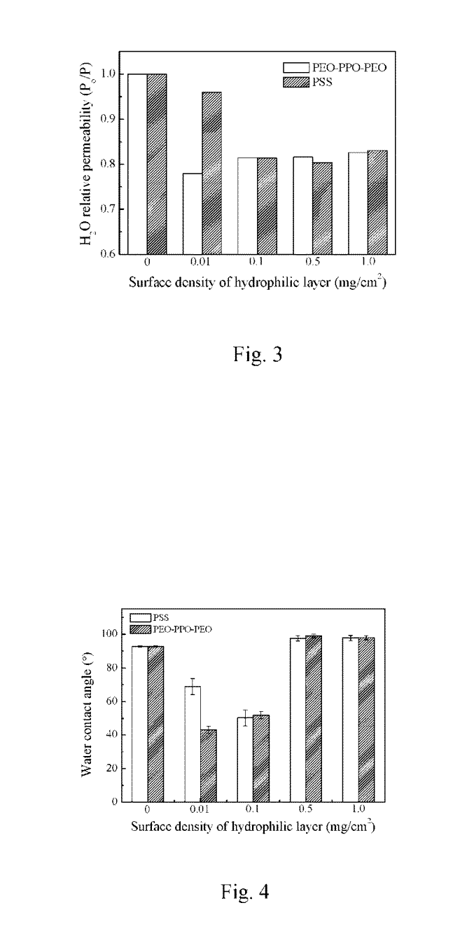

FIGS. 2 (a) to (c) show a schematic diagram illustrating a structure of a moisture barrier composite film according to one embodiment of the present invention where (a) shows TRG blended COC (COC/TRG) (arrows show moisture passes through the surface of COC and cannot be caught on the surface of the composite film); (b) shows the surface of the composite film has the hydrophilic layer PEO-PPO-PEO; and (c) shows COC/TRG having the hydrophilic layer PSS. FIG. 3 shows a schematic diagram illustrating the relationship of the surface density of the hydrophilic surface layer of the moisture barrier composite film and the relative moisture permeation rate according to one embodiment of the present invention. FIG. 4 shows a schematic diagram illustrating the relationship of the surface density of the hydrophilic surface layer of the moisture barrier composite film and the water contact angle according to one embodiment of the present invention. From FIG. 2, PEO-PPO-PEO has longer hydrophilic segments than PSS and thus catches more water molecules on the surface of the film so that water molecules aggregate to become larger on the surface and thus less water molecules permeate the film. Therefore, the better moisture barrier performance is shown.

As the adsorption density on the surface increases, the water vapor permeation rates of PEO-PPO-PEO/COC and PSS/COC modified films firstly are lowered and then slightly raised. As for PEO-PPO-PEO/COC and PSS/COC modified films, the preferred adsorption densities are about 0.01 and 0.1 mg/cm², respectively, which can lower the water vapor permeation rates to 22% and 18.6%, respectively. The result shows that the surface modification to become hydrophilic can effectively increase moisture barrier performance. If the density of the hydrophilic surface layer is too high, hydrophilicity of the surface cannot be shown because the water contact angle suddenly increases to 100°. It may be because air is hydrophobic and the modified layer during drying processing has its hydrophobic ends be exposed outside. As the modified layer is in contact with water, the hydrophilic ends turn to the surface. When the modified layer is too dense, the hydrophilic ends cannot turn to the surface because the entanglement between hydrophilic segments and hydrophobic segments.

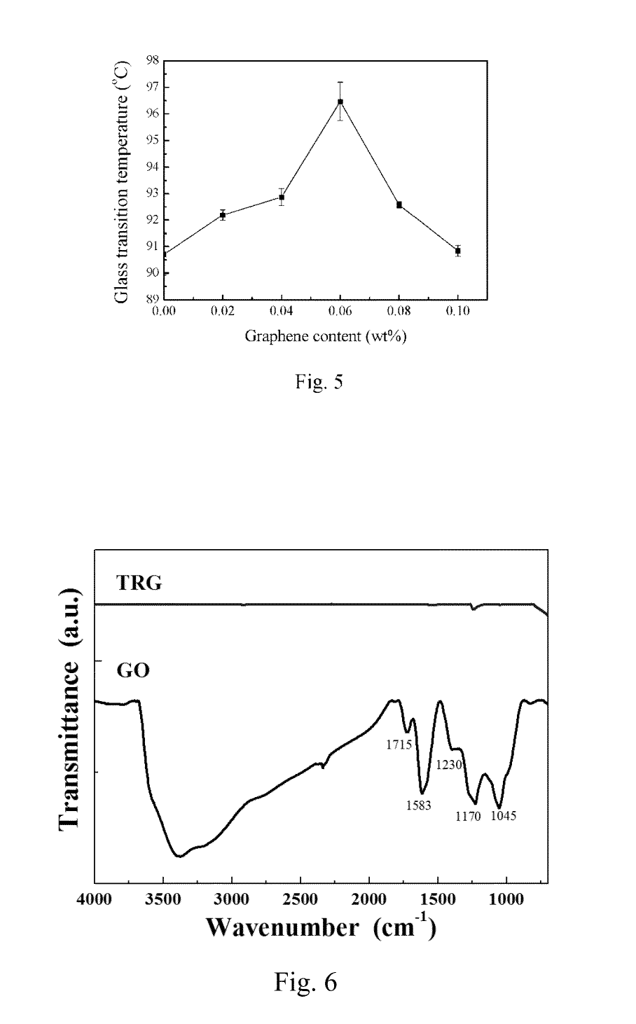

Furthermore, FIG. 5 shows a schematic diagram illustrating the relationship of the content of graphene in the moisture barrier composite film and glass transition temperature (Tg) according to one embodiment of the present invention. From FIG. 5, the interaction between graphene and COC is strong and the addition of graphene is within 0.02˜0.08 wt %, preferably 0.02˜0.06 wt % to have good dispersion to increase the glass transition temperature (Tg) and crystallinity so as to increase moisture barrier performance. If the addition quantity of graphene is too much, graphene starts to aggregate to lower the interaction with COC to lower the glass transition temperature (Tg) and crystallinity so as to decrease moisture barrier performance.

The thermal treatment at 80, 100 and 120° C. shows that the water vapor permeation rate of COC/TRG-0.06 is clearly decreased after thermal treatment. As the temperature of thermal treatment is higher, the water vapor permeation rate is lowered, which indicates that thermal treatment can effectively increase moisture barrier performance. When the temperature of thermal treatment rises from 80° C. to 100° C., the water vapor permeation rate is lowered about 14.5%. When the temperature of thermal treatment rises from 100° C. to 120° C., the water vapor permeation rate is lowered only about 2.0%. It indicates the importance of the temperature of thermal treatment higher or lower than Tg. As the temperature >Tg, molecular chains of COC have rigorous disturbance and the relaxation effect is obvious. Thus, molecular chains of COC can tightly adhere to surfaces of TRG crystals to reduce interfacial gaps so as achieve the promotion of the barrier effect.

In conclusion, according to the moisture barrier composite film and its preparation method of the present invention, the composite film has a high glass transition temperature, high transmittance, good mechanical strength and excellent moisture barrier performance. According to the moisture barrier composite film and its preparation method of the present invention, a solution film casting method is used to simply prepare a barrier film and an amphoteric polymer is used to perform surface hydrophilic processing to form a hydrophilic surface layer which can catch moisture to form a barrier layer to further increase moisture barrier performance. Furthermore, thermal treatment after the composite film is formed can further increase moisture barrier performance.

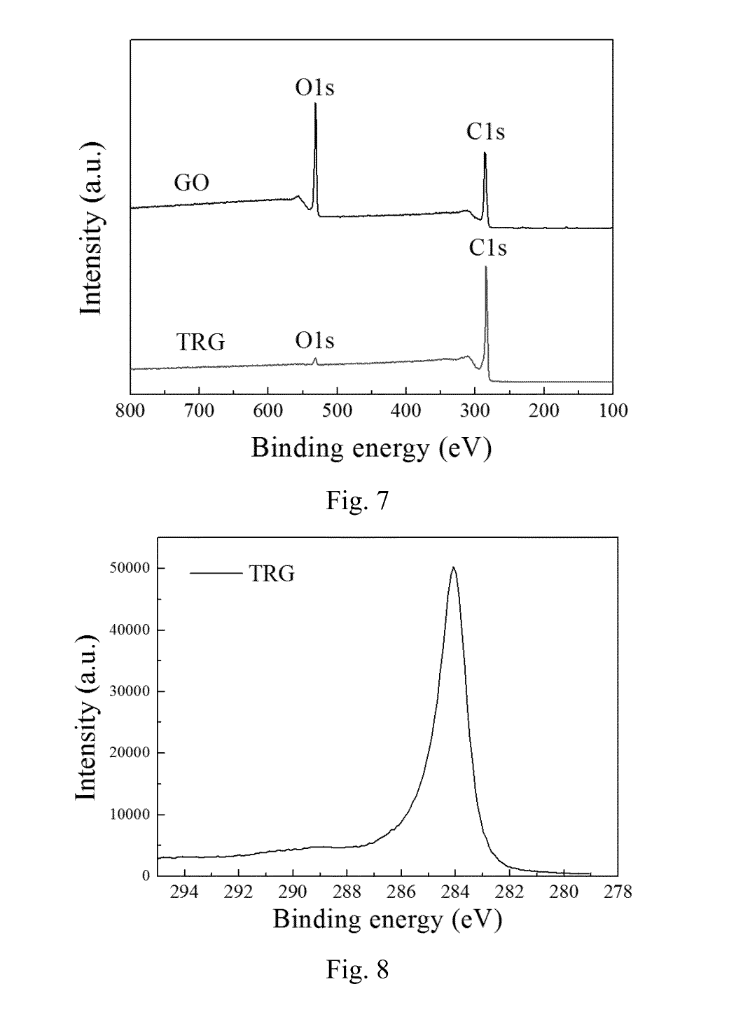

Moreover, FIG. 6 shows a schematic diagram illustrating FTIR spectra of graphene and TRG of the moisture barrier composite film according to one embodiment of the present invention. From IR spectra, a small peak at 1170 cm⁻¹ shows the residual C—O—C epoxy groups. It indicates that oxygen containing groups on GO are almost removed after thermal reduction processing. FIG. 7 shows a schematic diagram illustrating X-ray photoelectron spectra of graphene and TRG of the moisture barrier composite film according to one embodiment of the present invention. From FIG. 7, the peak due to oxygen is reduced after thermal reduction processing. From Table 1, the original or unprocessed graphene oxide contains about 30 mol % of oxygen elements and the thermally reduced graphene contains only about 2.86 mol % of oxygen elements. The ratio of C/O is about 34.0 and chemically reduced graphene (CRG) has a ratio of C/O be around 2.5˜21.2. It indicates TRG has a higher degree of reduction than CRG. FIG. 8 shows a schematic diagram illustrating X-ray photoelectron C1s spectra of TRG of the moisture barrier composite film according to one embodiment of the present invention. The main structure of TRG is C—C/C═C bonding and it indicates that it has the chemical structure of the original graphite.

TABLE 1

| Material | C (%) | O (%) |
|---|---|---|
| GO | 69.36 | 30.64 |
| TRG | 97.14 | 2.86 |

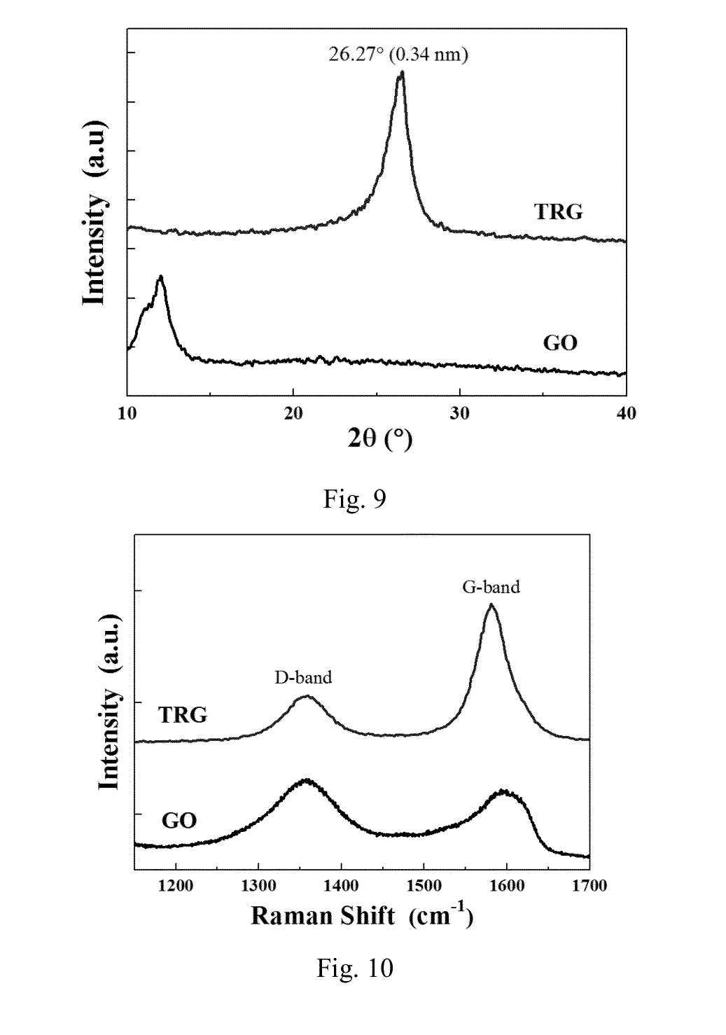

A wide angle X-ray diffraction and a Raman spectrometer are used to analyze. FIG. 9 shows a schematic diagram illustrating X-ray diffraction spectra of graphene and TRG of the moisture barrier composite film according to one embodiment of the present invention. The diffraction peak of GO after thermal reduction processing is shifted from 11.1° to 26.26° which is close to the peak of the original graphite. It indicates that TRG has partially piling up and aggregation to form the structure which is graphite-like. FIG. 10 shows a schematic diagram illustrating Raman spectra of graphene and TRG of the moisture barrier composite film according to one embodiment of the present invention. The peaks at 1360 cm⁻¹ and 1600 cm⁻¹ show the typical D-band and G-band scattering peaks which correspond to sp³ and sp² carbon bonding. The D-band represents the defect position in the graphite structure while the G-band represents the crystalline structure. Therefore, after thermal reduction processing, the defect position due to oxidation on GO can rearrange to the sp² structure of graphite crystals. Such a crystalline structure assist in promotion of the barrier performance of the composite film.

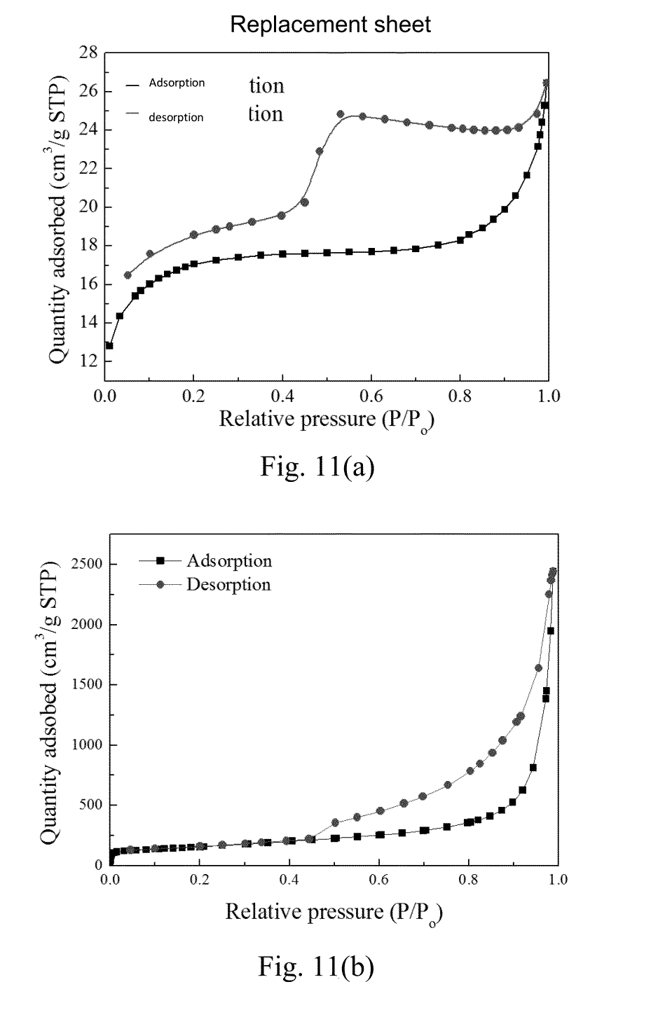

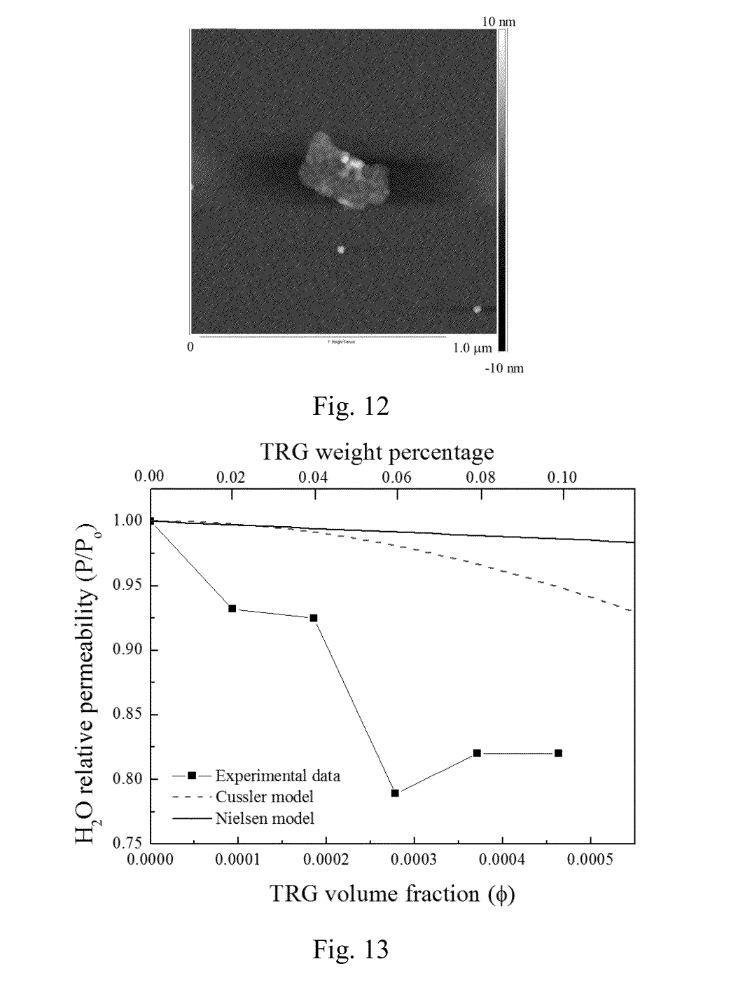

FIG. 11(a) shows a schematic diagram illustrating the relationship of graphene of the moisture barrier composite film and the absorption and desorption of N₂ according to one embodiment of the present invention and FIG. 11(b) shows a schematic diagram illustrating the relationship of TRG of the moisture barrier composite film and the absorption and desorption of N₂ according to one embodiment of the present invention. From FIG. 11, the adsorption is an S-shaped curve. At a low pressure, the amount of adsorption quickly increases and then turns flat where the turning point of the curves indicates saturation of adsorption of a single layer which is generally the behavior of a non-porous or micro-porous (<2 nm) material. At a high pressure (P/P₀˜1.0), the amount of adsorption quickly increases due to capillary condensation. For the desorption curve, the lagging phenomenon is observed and may be because of existence of the meso-porous structure (2˜50 nm) in the material. The adsorption specific surface areas of GO and TRG are calculated based on BET and are 60 m²/g and 540 m²/g for GO and TRG, respectively. The result shows that the high speed on temperature rising (>2000° C.) causes the oxygen containing groups between GO layers to break to form CO or CO₂ to produce a huge pressure between layers (at 300° C.=40 MPa and at 1000° C.=1300 MPa) to separate GO so that a high specific surface area is obtained. To analyze the size of TRG, TRG is dispersed in chloroform to have concentration of 10 ppm and a drop of the solution is dripped on a silicon wafer and dried to be observe by AFM. FIG. 12 shows a schematic diagram illustrating the height distribution of TRG of the moisture barrier composite film by an atomic force microscope according to one embodiment of the present invention. The horizontal size of TRG is about 300 nm and the thickness is about 1.9 nm. It indicates that the number of TRG layers are two. The aspect ratio (length/thickness) of TRG is about 150.

FIG. 13 shows a schematic diagram illustrating the relationship of the content of TRG of the moisture barrier composite film and the relative moisture permeation rate (P/P₀) according to one embodiment of the present invention where P is the permeation rate of the COC/TRG-X composite film and P₀ is the permeation rate of the COC film. As the water vapor permeation rate of the COC/TRG composite film is firstly lowered and then slightly raised. At 0.06 wt %, the minimum water vapor permeation rate is achieve and is about 21% lower than the original COC film. On the other hand, compared to Cussler and Nielsen models, it is found that according to the present invention the addition amount is 0˜0.1 wt %, the COC/TRG film has much lower permeation rate than the prediction based on Cussler and Nielsen models.

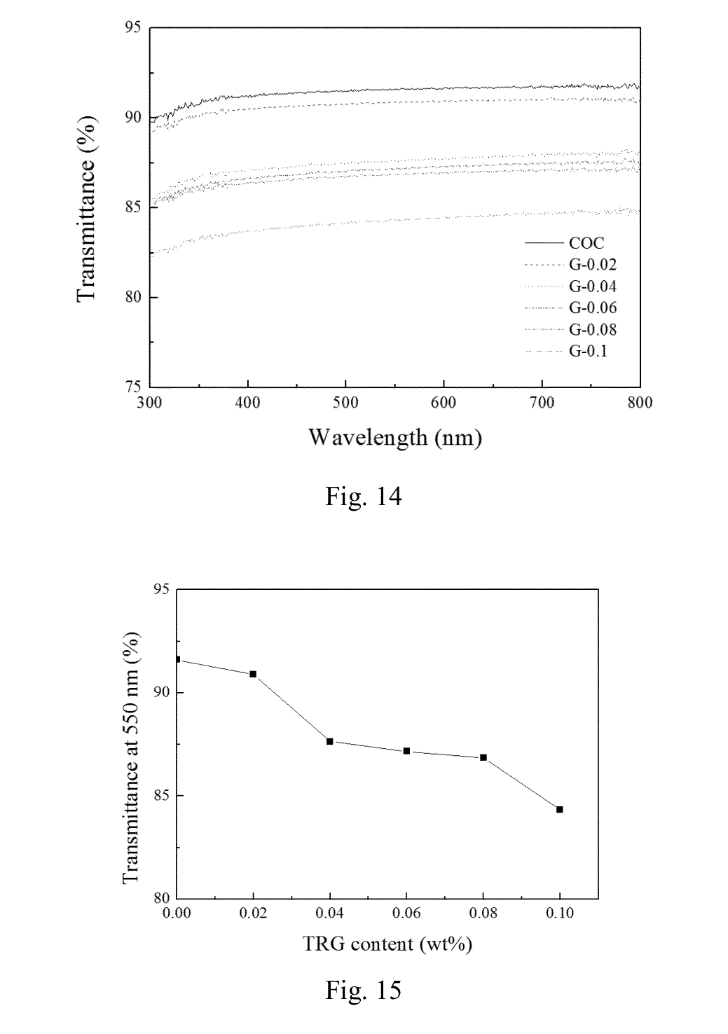

FIG. 14 shows a schematic diagram illustrating UV-Vis spectra of the COC/TRG-X composite film with different content of TRG according to one embodiment of the present invention. As the content of TRG increases, the transmittance at 300 nm˜800 nm is lowered. FIG. 15 shows a schematic diagram illustrating the relationship of the content of TRG of the moisture barrier composite film and transmittance at 550 nm according to one embodiment of the present invention. It indicates that the transmittance is lowered as the content of TRG increases. When the content of TRG reaches 0.1 wt %, the transmittance is lower than 85% which is the minimum requirement for electronic products. Therefore, based on the data of the water vapor permeation rate and the transmittance, a film having the best barrier performance and transmittance >85% is COC/TRG-0.06.

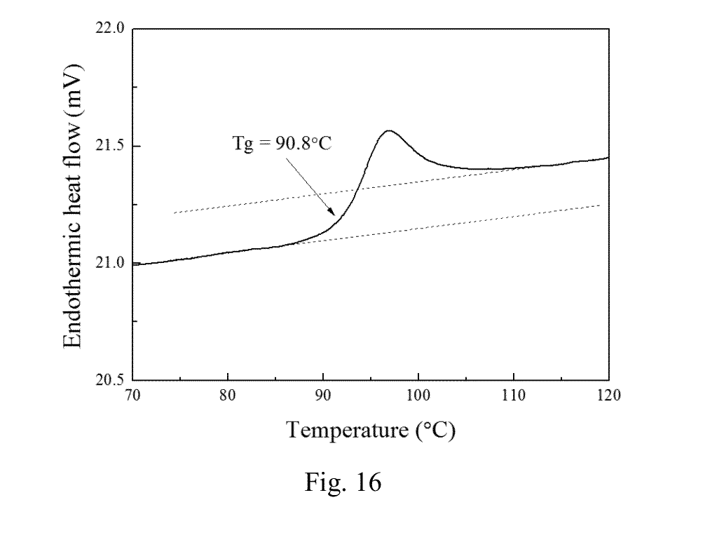

FIG. 16 shows a schematic diagram illustrating DSC spectrum of COC film of the moisture barrier composite film according to one embodiment of the present invention. From FIG. 16, Tg of COC is 90.8° C. Therefore, the temperature of thermal treatment is chosen to be 80˜100° C. After thermal treatment, the water vapor permeation rate of the COC/TRG-0.06 film is clearly reduced.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A method for preparing a moisture barrier composite film, comprising:
providing a graphene dispersed solution;
dissolving cyclic olefin copolymer in the graphene dispersed solution to obtain a casting solution;
performing a solution film casting procedure to coat the casting solution on a glass substrate to form a coating film; and
performing a film drying procedure to dry the coating film to separate from the glass substrate to obtain a moisture barrier composite film.

2. The method according to claim 1, further comprising:
performing a surface modification procedure to modify surfaces of the moisture barrier composite film to become hydrophilic by using a hydrophilic modifier to coat on the surfaces of the moisture barrier composite film by a drop casting method to form a hydrophilic surface layer on the surfaces of the moisture barrier composite film after drying.

3. The method according to claim 2, wherein the hydrophilic modifier is made by dissolving an amphoteric polymer in an ethanol containing aqueous solution.

4. The method according to claim 3, wherein the amphoteric polymer is (poly(ethylene oxid)-poly(propylene oxid)-poly(ethylene oxid) triblock copolymer or poly(4-styrenesulfonic acid), the ethanol containing aqueous solution is an aqueous solution containing 20 wt % of ethanol and the hydrophilic surface layer has a density with a range of 0.01˜1.0 mg/cm².

5. The method according to claim 1, wherein the graphene dispersed solution is obtained by thermally reduce graphene oxide to produce thermally reduced graphene and dissolving the thermally reduced graphene in chloroform.

6. The method according to claim 1, further comprising:
performing a stripping procedure after the film drying procedure to separate from the glass substrate to obtain a moisture barrier composite film.

7. The method according to claim 1, wherein the cyclic olefin copolymer is formed by polymerization of ethylene and norbornene.

8. The method according to claim 5, wherein the thermally reduced graphene has a molar fraction of oxygen element be less than 3 mol %.

9. A moisture barrier composite film, formed by having a mixture of thermally reduced graphene and cyclic olefin copolymer be formed into a film and forming a hydrophilic surface layer on surfaces of the moisture barrier composite film by a hydrophilic agent;
wherein a ratio of carbon atoms to oxygen atoms in thermally reduced graphene is more than 30 and the hydrophilic surface layer has a density of 0.01˜1.0 mg/cm².

10. The moisture barrier composite film according to claim 9, wherein the thermally reduced graphene in the moisture barrier composite film is 0.05˜0.8 wt %; the hydrophilic agent is poly(4-styrenesulfonic acid); and the hydrophilic surface layer has a density of 0.1 mg/cm².

11. The moisture barrier composite film according to claim 9, wherein the thermally reduced graphene in the moisture barrier composite film is 0.05˜0.8 wt %; and the hydrophilic agent is (poly(ethylene oxid)-poly(propylene oxid)-poly(ethylene oxid) triblock copolymer; and the hydrophilic surface layer has a density of 0.01 mg/cm².

12. The moisture barrier composite film according to claim 9, wherein the moisture barrier composite film has a water contact angle of less than 60 degrees and has a water vapor permeation rate of less than 1.0 g·mm/m²/day.

13. The moisture barrier composite film according to claim 9, wherein the thermally reduced graphene in the moisture barrier composite film is about 0.06 wt %; the hydrophilic agent is (poly(ethylene oxid)-poly(propylene oxid)-poly(ethylene oxid) triblock copolymer; the hydrophilic surface layer has a density of 0.01 mg/cm²; and the moisture barrier composite film has light transmittance of more than 85% and a water vapor permeation rate of less than 0.07 g·mm/m²/day.

14. The moisture barrier composite film according to claim 9, wherein the moisture barrier composite film has a glass transition temperature higher than the cyclic olefin copolymer that forms into the moisture barrier composite film.

15. The moisture barrier composite film according to claim 9, wherein the moisture barrier composite film has a glass transition temperature of higher than 95° C.
